(19) United States
(12) Patent Application Publication
(10) Pub. No.: US 2014/0226752 A1
(43) Pub. Date: Aug. 14, 2014

(54) SATELLITE BROADCASTING AND COMMUNICATION TRANSMITTING APPARATUS AND METHOD FOR BROADBAND SATELLITE AND COMMUNICATION SERVICE

(71) Applicant: Electronics and Telecommunications Research Institute, Daejeon (KR)

(72) Inventors: Pan Soo KIM, Daejeon (KR); Deock Gil OH, Daejeon (KR)

(73) Assignee: Electronics and Telecommunications Research Institute, Daejeon (KR)

(21) Appl. No.: 14/175,412

(22) Filed: Feb. 7, 2014

(30) Foreign Application Priority Data
Feb. 8, 2013 (KR) 10-2013-0014487
Jul. 10, 2013 (KR) 10-2013-0080785

(51) Int. Cl. H04L 1/00; H04B 1/62

(52) U.S. Cl. CPC H04L 1/0042; H04B 1/62
USPC 375/296

(57) ABSTRACT

Provided is a satellite broadcasting and communication transmitting apparatus and method for a broadband satellite broadcasting and communication service, including a forward error correction (FEC) encoder to generate an FEC frame, a bit mapping framer to perform bit mapping on the generated FEC frame, and a predistorter to predistort the bit mapped frame.

### CROSS-REFERENCE TO RELATED APPLICATIONS

This application claims the priority benefit of Korean Patent Application No. 10-2013-0014487, filed on Feb. 8, 2013, and Korean Patent Application No. 10-2013-0080785, filed on Jul. 10, 2013, in the Korean Intellectual Property Office, the disclosures of which are incorporated herein by reference.

### BACKGROUND

1. Field of the Invention

The present invention relates to a technical idea of performing predistortion at a transmitting end and increasing efficiency for a broadband satellite broadcasting and communication service.

2. Description of the Related Art

In conventional technology, there are two types of distortions which occur during satellite transmission, including a linear distortion and a non-linear distortion. The linear distortion may indicate a phenomenon in which a signal phase and interference are linearly distorted such as a Finite Impulse Response (FIR) of an input multiplexer filter of a channel repeater.

The nonlinear distortion may occur when an amplifier of a gateway or a transponder operates in a nonlinear section to maximize power efficiency.

Recently, technology for minimizing an excess band compared to a Nyquist filter is gaining attention. In this case, interference in an adjacent channel may increase and thus, technology for correcting a distortion while passing a distorted channel is necessary.

In general, improvement is made using a linear and/or nonlinear equalizer at a receiving end. However, complexity may increase when the equalizer is used at the receiving end and thus, a price of a receiver may increase.

### SUMMARY

According to an aspect of the present invention, there is provided a satellite broadcasting and communication transmitter including a forward error correction (FEC) encoder to generate an FEC frame, a bit mapping framer to perform bit mapping on the generated FEC frame, and a predistorter to predistort the bit mapped frame.

The predistorter may generate a predistortion symbol based on symbols of the bit mapped frame and perform predistortion using the generated predistortion symbol.

The predistorter may calculate a sum of the symbols of the bit mapped frame based on design parameters associated with a memory component and generate the predistortion symbol based on a result of the calculating.

The bit mapping framer may perform bit mapping on the generated FEC frame based on a predetermined constellation.

The bit mapping framer may perform the bit mapping on the generated FEC frame based on at least one of an applicable area and a status of a transmission channel.

The bit mapping framer may perform the bit mapping on the FEC frame based on at least one constellation among π/2 Binary Phase Shift Keying (BPSK), Quadrature Phase Shift Keying (QPSK), 8 Phase Shift Keying (8PSK), 16 Amplitude and Phase Shift Keying (16APSK), 32APSK, and 64APSK.

The bit mapping framer may add a physical layer (PL) header to the bit mapped frame.

The satellite broadcasting and communication transmitter may further include a baseband filtering modulator to perform baseband filtering modulation to wirelessly transmit the predistorted frame.

According to another aspect of the present invention, there is provided a satellite broadcasting and communication transmitting method including generating a forward error correction (FEC) frame by an FEC encoder, performing bit mapping on the generated FEC frame by a bit mapping framer, and predistorting the bit mapped frame by a predistorter.

The predistorting may include generating a predistortion symbol based on symbols of the bit mapped frame and performing predistortion using the generated predistortion symbol.

The generating of the predistortion symbol may include calculating a sum of the symbols of the bit mapped frame based on a design parameter associated with a memory component and generating the predistortion symbol based on a result of the calculating.

The performing of the bit mapping may include performing the bit mapping on the generated FEC frame based on a predetermined constellation.

The performing of the bit mapping may include performing the bit mapping on the generated FEC frame based on at least one of an applicable area and a status of a transmission channel.

The satellite broadcasting and communication transmitting method may further include performing baseband filtering modulation by a baseband filtering modulator to wirelessly transmit the predisorted frame.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a satellite broadcasting and communication transmitter according to an embodiment of the present invention;

FIG. 2 illustrates a Peak to Average Power Ratio (PAPR) Complementary Cumulative Distribution Function (CCDF) of Quadrature Phase Shift Keying (QPSK) modulation based on an excessive bandwidth factor, for example, a roll off factor, according to an embodiment of the present invention;

FIG. 3 is a block diagram illustrating a satellite broadcasting and communication transmitter according to another embodiment of the present invention;

FIG. 4 is a diagram illustrating a simulation chain of a predistortion technology for a nonlinear distortion;

FIG. 5 illustrates a result of Signal to Distortion Ratio (SDR) of a satellite broadcasting and communication transmitter according to an embodiment of the present invention;

FIG. 6 illustrates a result of a spectral efficiency in comparison to Carrier to Noise Ratio (C/N)+Output Backoff (OBO); and

FIG. 7 is a flowchart illustrating a satellite broadcasting and communication transmitting method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

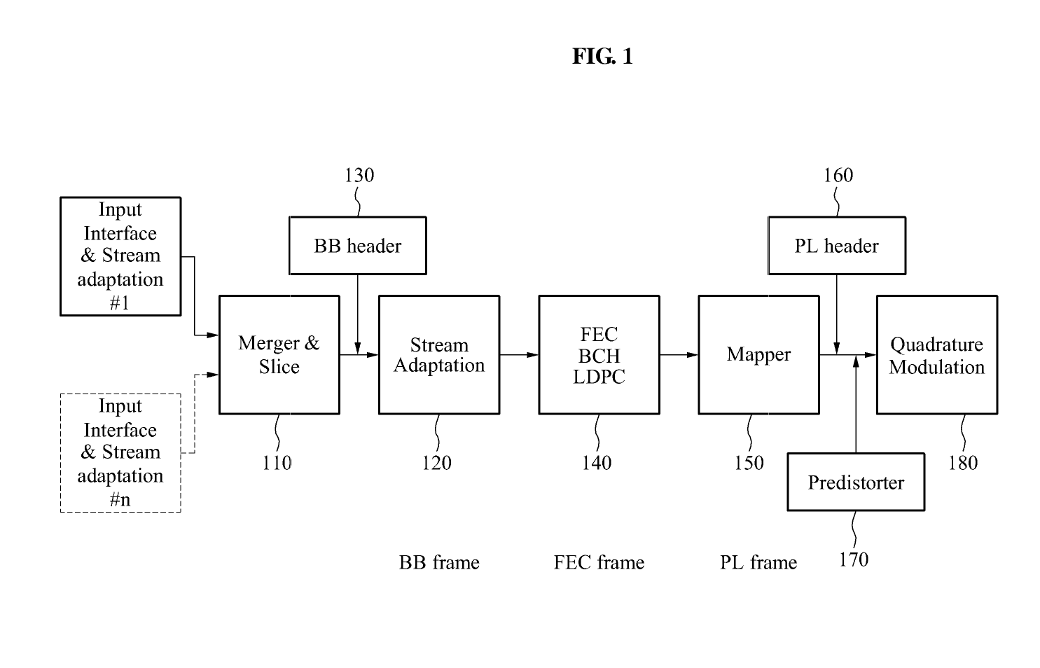

FIG. 1 is a block diagram illustrating a satellite broadcasting and communication transmitter according to an embodiment of the present invention.

The satellite broadcasting and communication transmitter may be provided in a form of a satellite transceiver operable in a broad Signal to Noise Ratio (SNR) environment, for example, a low SNR environment, and may be applied to a Digital Video Broadcasting-Satellite-Second generation (DVB-S2) standard based network.

A general transmitter may include an input stream interface, a merger and slice configuration unit, a baseband (BB) header inserter, a forward error correction (FEC) encoder, for example, a BCH+Low-Density Parity-Check (LDPC) encoder, a modulator, a physical layer (PL) frame configuration unit, a PL header inserter, a BB filter, and a quadrature modulator. Here, the satellite broadcasting and communication transmitter may further include a unit for predistortion.

More particularly, the satellite broadcasting and communication transmitter may include a mode adaptor 110, a stream adaptor 120, a BB header 130, an FEC encoder 140, a mapper 150, a PL header processor 160, a predistorter 170, and a modulator 180.

The mode adaptor 110 may be determined based on an application, and perform functions such as providing an input stream interface, recovering an input stream, eliminating a null-packet for an Adaptive Coding and Modulation (ACM) mode and a Transport Stream (TS) input format, performing Cyclic Redundancy Check-8 (CRC-8) encoding for error detection, and performing an input stream mixing function for a multi-input stream. The BB header 130, as a frame configuring format, may be provided at a front end of a data field to inform a receiver of an input stream format and a form of the mode adaptor 110.

The stream adaptor 120 may perform padding and BB scrambling to form a BB frame.

The FEC encoder 140 may correct an error based on an external code such as BCH and an internal code such as LDPC with various code rates, and determine a length of an FEC code block to be 64,800 bits or 16,200 bits based on an application.

Also, the FEC encoder 140 may perform bit interleaving with 8 Phase Shift Keying (8PSK), 16 Amplitude and Phase Shift Keying (16APSK), 32APSK, and 64APSK modulation, but not with Binary Phase Shift Keying (BPSK) and Quadrature Phase Shift Keying (QPSK) modulation.

The mapper 150 may perform modulation based on π/2 BPSK, QPSK, 8PSK, 16APSK, 32APSK, or 64APSK constellations, and determine a bit mapping based on an applicable area or a status of a transmission channel. Also, the mapper 150 may add a PL header by performing 16K LDPC encoding with the π/2 BPSK modulation to form a spread frame with a length of 16290 and thus, replace an existing Modulation and Coding (MODCOD) frame with the spread frame.

The PL header processor 160 may insert the PL header in the replaced spread frame.

The predistorter 170 may mitigate a distortion component of a signal occurring when passing a nonlinear channel.

The modulator 180 may perform synchronization with a block code, for example the FEC frame, insert a dummy frame, as necessary, to maintain a symbol speed, insert a pilot symbol for frame synchronization and carrier wave recovery of the PL header, for example, modulation and code rate information of the receiver, and configure a PL frame.

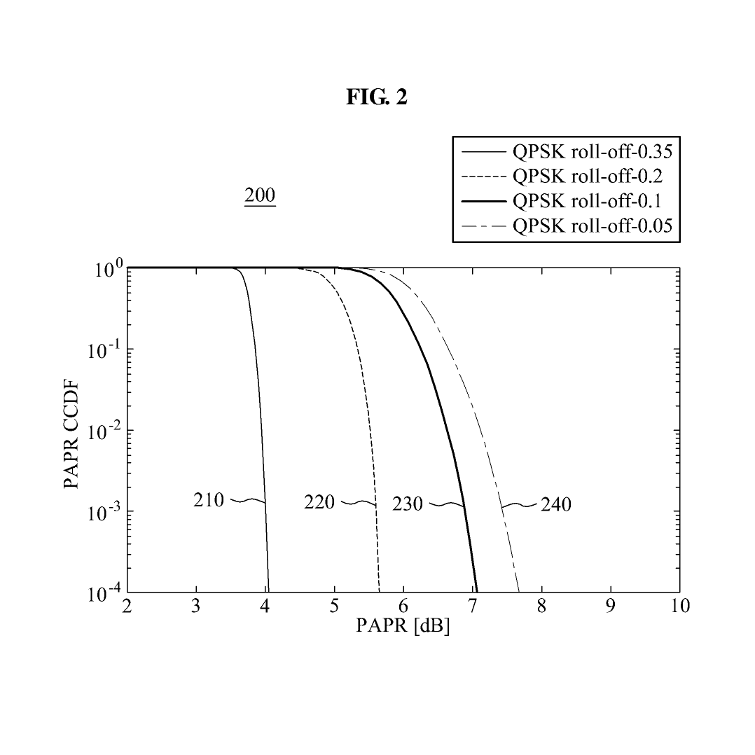

FIG. 2 illustrates a Peak to Average Power Ratio (PAPR) Complementary Cumulative Distribution Function (CCDF) of Quadrature Phase Shift Keying (QPSK) modulation based on an excessive bandwidth factor, for example, a roll off factor, according to an embodiment of the present invention.

Referring to FIG. 2, a result value based on a QPSK modulated signal with a roll off factor of 0.35 is indicated as a curve 210. A result value based on a QPSK modulated signal with a roll off factor of 0.2 is indicated as a curve 220. A result value based on a QPSK modulated signal with a roll off factor of 0.1 is indicated as a curve 230. A result value based on a QPSK modulated signal with a roll off factor of 0.05 is indicated as a curve 240.

In a field of a satellite broadcasting and communication system, technology for filtering a signal occupied band to be a band close to a Nyquist filter is being introduced to improve transmission efficiency. When transmitting a signal in a filtered state in which the roll off factor is a low, a PAPR of the signal may increase as shown in FIG. 2.

A large PAPR of the signal may indicate that a distortion component of the signal increases when passing a nonlinear channel. According to an embodiment of the present invention, the increase in the distortion component of the signal that may occur when passing the nonlinear channel is mitigated by applying a predistortion technology using the predistorter 170.

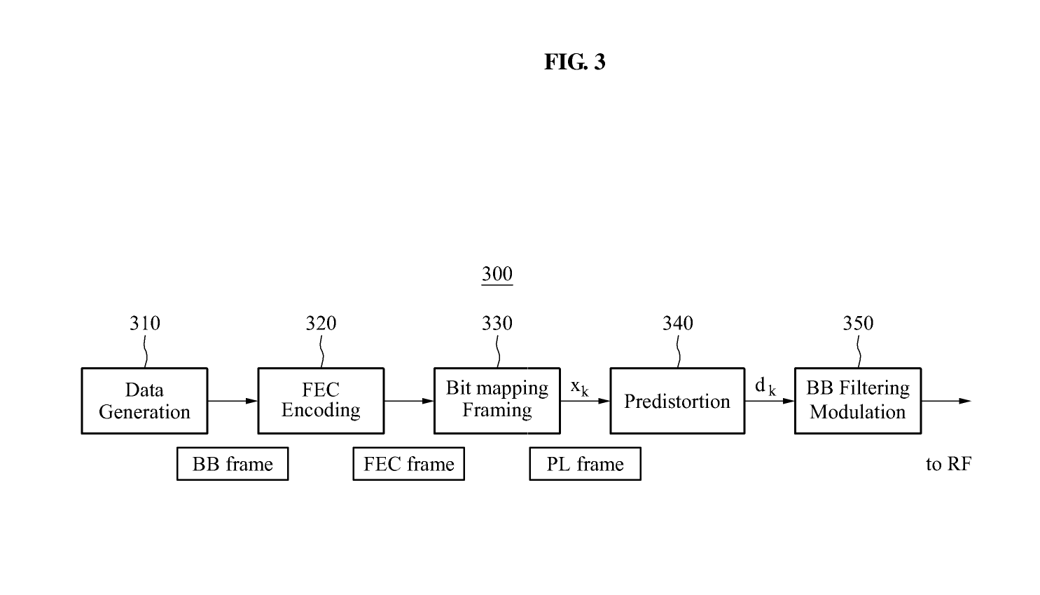

FIG. 3 is a block diagram illustrating a satellite broadcasting and communication transmitter 300 according to another embodiment of the present invention.

According to an embodiment of the present invention, the satellite broadcasting and communication transmitter 300 may include a data generator 310, an FEC encoder 320, a bit mapping framer 330, and a predistorter 340.

The satellite broadcasting and communication transmitter 300 may generate an FEC frame by performing error correction on data generated by the data generator 310 based on an external code such as BCH and an internal code such as LDPC with various code rates.

The data generator 310 may generate a BB frame by performing functions such as an input stream interface, an input stream recovery, an elimination of a null-packet for an ACM mode and a TS input format, a CRC-8 encoding for error detection, and an input stream mixing function for a multi-input stream.

The bit mapping framer 330 may perform bit mapping on the generated FEC frame.

For example, a PL header may be added by performing 16K LDPC encoding with a π/2 BPSK modulation to form a spread frame with a length of 16290 and thus, an existing MODCOD frame may be replaced with the spread frame.

The bit mapping framer 330 may perform bit mapping on the generated FEC frame based on at least one constellation among π/2 BPSK, QPSK, 8PSK, 16APSK, 32APSK, and 64APSK.

The bit mapping framer 330 may perform the bit mapping on the FEC frame based on at least one of an applicable area and a status of a transmission channel.

The bit mapping framer 330 may add the PL header to the bit mapped frame.

The predistorter 340 may predistort the bit mapped frame.

The predistorter 340 may generate a predistortion symbol based on symbols of the bit mapped frame and perform predistortion using the generated predistortion symbol.

The predistorter 340 may calculate a sum of the symbols of the bit mapped frame based on design parameters associated with a memory component and generate the predistortion symbol based on a result of the calculating.

For example, the predistorter 340 may perform the predistortion based on Equation 1.

$${d}_{k} = {\sum }_{t = - {M}_{i}}^{{M}_{1}} {c}_{i} {x}_{k + i} + {\sum }_{i = - {M}_{3}}^{{M}_{3}} {\sum }_{j = - {M}_{3}}^{{M}_{3}} {\sum }_{i = - {M}_{3}}^{{M}_{3}} {c}_{ijl} {x}_{k + i} {x}_{k + j} {x}_{k + l}^{*} ++ {\sum }_{i = - {M}_{5}}^{{M}_{5}} {\sum }_{j = - {M}_{5}}^{{M}_{5}} {\sum }_{l = - {M}_{5}}^{{M}_{5}} {\sum }_{m = - {M}_{5}}^{{M}_{5}} {\sum }_{n = - {M}_{5}}^{{M}_{5}} {c}_{ijlmn} {x}_{k + i} {x}_{k + j} {x}_{k + l} {x}_{k + m}^{*} {x}_{k + n}^{*} \qquad [ Equation 1 ]$$

Here, xₖ denotes a kth symbol of the PL frame and dₖ denotes a corresponding predistortion symbol.

M₁, M₃, and M₅ denote design parameters indicating a first, a third, and a fifth memory component, respectively. c denotes a factor component minimizing a difference between an original signal and a distorted signal.

The predistorter 340 may reduce a value of a factor to be stored and fix the value of the factor irrespective of a number of modulation.

The satellite broadcasting and communication transmitter 300 may further include a BB filtering modulator 350 to perform BB filtering modulation to wirelessly transmit the predistorted frame.

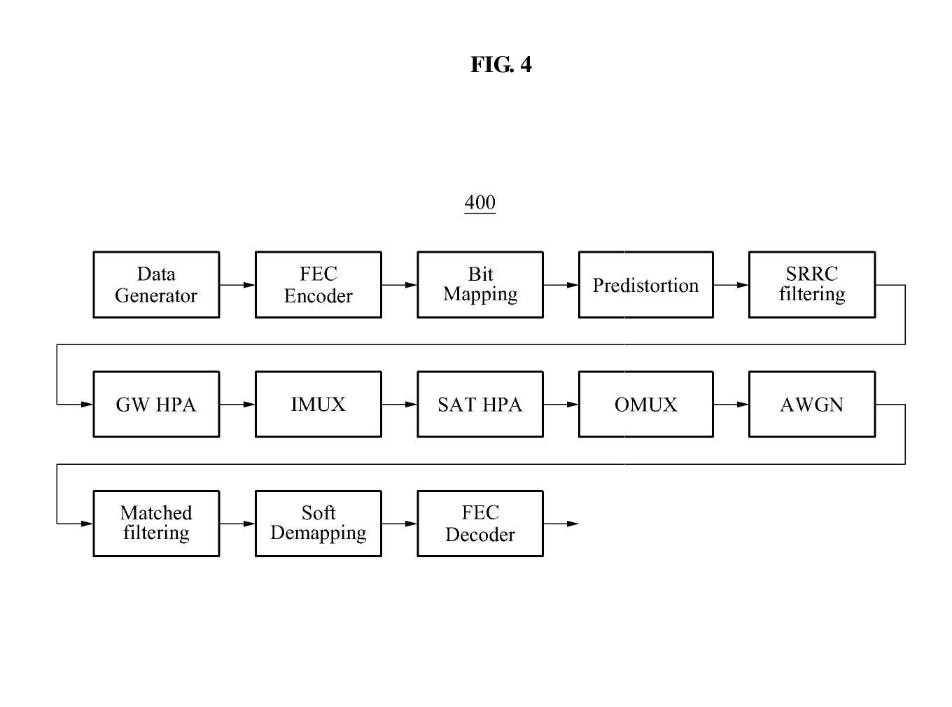

FIG. 4 is a diagram illustrating a simulation chain of a predistortion technology for a nonlinear distortion.

FIG. 4 illustrates a structure 400 related to a simulation conducted to demonstrate a feature of the present invention in a nonlinear channel environment. Table 1 shown below indicates parameter values used to conduct the simulation using the structure 400.

TABLE 1

| Parameter Name | Parameter Value |
|---|---|
| GW HPA IBO [dB] | 17 |
| IMUX BW [MHz] | 36 |
| Satellite HPA type | Non-linear |
| Satellite HPA IBO [dB] | 0 |
| OMUX BW [MHz] | 36 |

As shown in Table 1, GW HPA IBO subsequent to Square-Root Raised Cosine (SRRC) filtering may be determined to be 17 decibels (dB), and IMUX BW may be determined to be 36 megahertz (MHz). Also, a type of Satellite HPA may be determined to be nonlinear, and Satellite HPA IBO and OMUX BW may be determined to be 0 dB and 36 MHz, respectively.

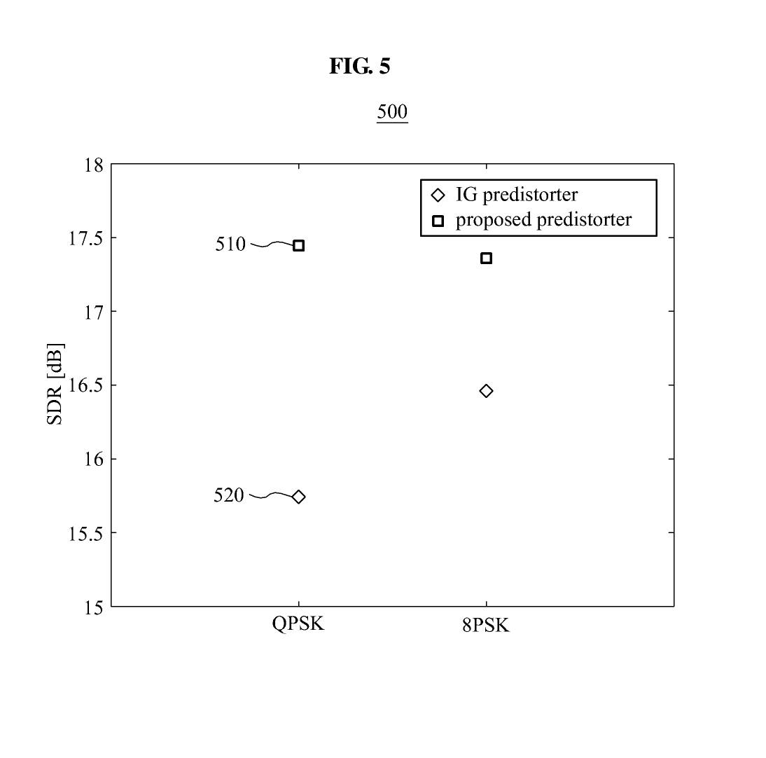

FIG. 5 illustrates a result of Signal to Distortion Ratio (SDR) of a satellite broadcasting and communication transmitter according to an embodiment of the present invention.

Referring to FIG. 5, the simulation illustrated in FIG. 4 and Table 1 is conducted, an SDR may be confirmed to decrease in comparison to a conventional E. Casini technology.

In FIG. 5, a result value related to predistortion of Implementation Guideline (IG) is indicated as 510 and a result value related to predistortion according to an embodiment of the present invention is indicated as 520.

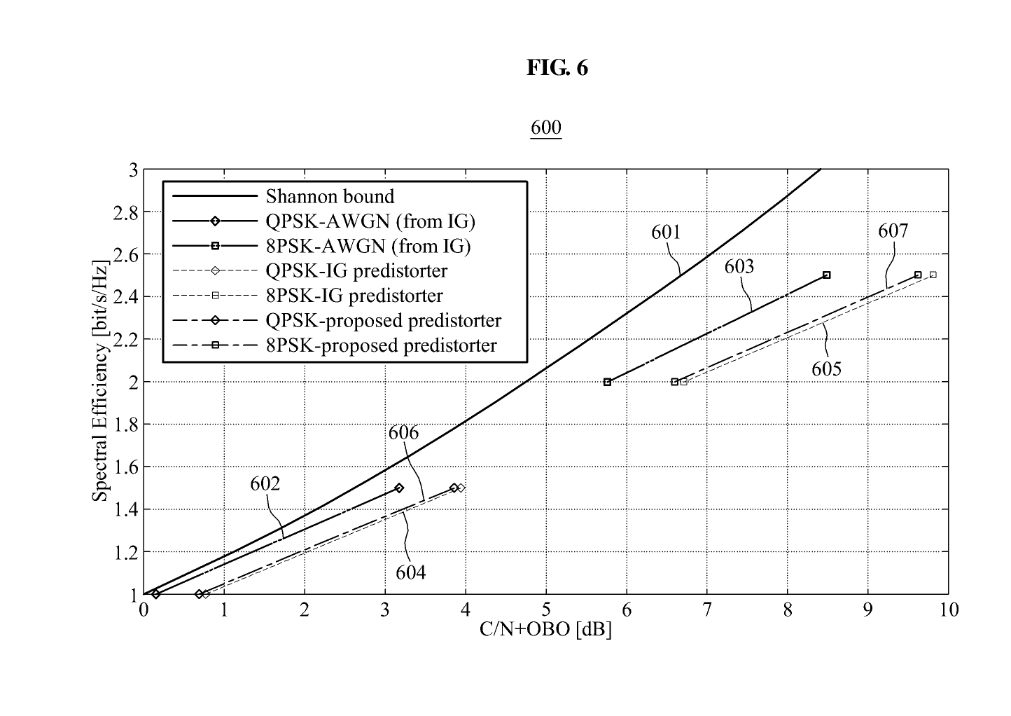

FIG. 6 illustrates a result of a spectral efficiency in comparison to Carrier to Noise Ratio (C/N)+Output Backoff (OBO).

A graph 600 indicates improvement of transmission efficiency of an entire system.

More particularly, Shannon bound is indicated as a curve 601.

Also, a curve 602 indicates a spectral efficiency in comparison to C/N+OBO based on QPSK-AWGN of the IG and a line 603 indicates a spectral efficiency in comparison to C/N+OBO based on 8PSK-AWGN of the IG.

Further, a line 604 indicates a spectral efficiency in comparison to C/N+OBO based on a result of predistortion according to an embodiment of the present invention, and a line 605 indicates a spectral efficiency in comparison to C/N+OBO based on predistortion of 8PSK-IG.

Further, a line 606 indicates a spectral efficiency of a QPSK modulated signal in comparison to C/N+OBO based on a result of predistortion according to an embodiment of the present invention, and a line 607 indicates a spectral efficiency of a 8PSK modulated signal in comparison to C/N+OBO based on a result of predistortion according to an embodiment of the present invention.

Using a satellite broadcasting and communication transmitter disclosed herein may improve deterioration in transmission efficiency caused by a channel distortion in a broadband satellite broadcasting and communication technology. Also, transmitting, in a form of a predistortion, a distortion occurring in a channel environment at a transmitting end may reduce the distortion in a channel and reduce complexity at a receiving end by correcting a remaining distortion at the receiving end.

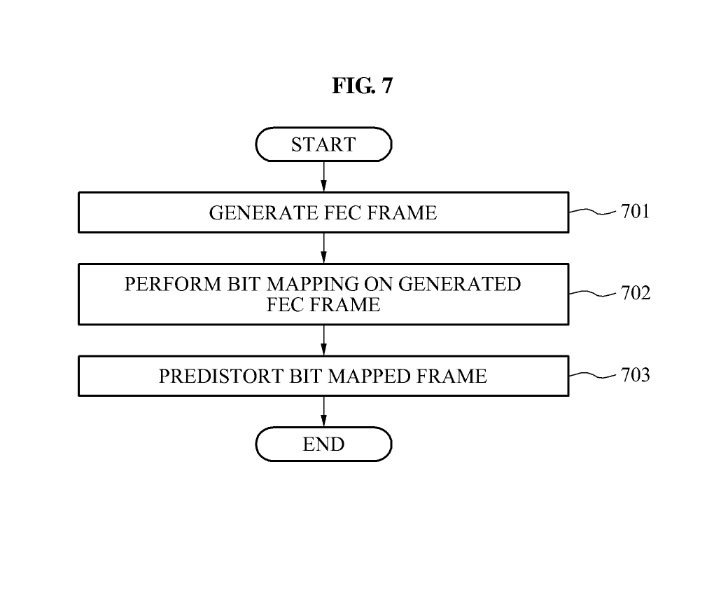

FIG. 7 is a flowchart illustrating a satellite broadcasting and communication transmitting method according to an embodiment of the present invention.

Referring to FIG. 7, in operation 701, an FEC frame may be generated.

In operation 702, bit mapping may be performed on the generated FEC frame.

For example, the bit mapping may be performed on the generated FEC frame based on a predetermined constellation.

The bit mapping may be performed on the generated FEC frame based on at least one of an applicable area and a status of a transmission channel.

In operation 703, the bit mapped frame may be predistorted.

For the predistortion, a predistortion symbol may be generated based on symbols of the bit mapped frame and the bit mapped frame may be predistorted using the generated predistortion symbol.

For the predistortion, a sum of the symbols of the bit mapped frame may be calculated in consideration of design parameters, based on a memory component. Also, the predistortion symbol may be generated based on a result of the calculating.

Furthermore, BB filtering modulation may be performed by a BB filtering modulator to wirelessly transmit the predistored frame.

According to an embodiment of the present invention, deterioration in transmission efficiency caused by channel distortion in a broadband satellite broadcasting and communication technology may be improved.

According to another embodiment of the present invention, a distortion in a channel may be reduced by transmitting a predistortion for the distortion occurring in a channel environment at a transmitting end.

According to still another embodiment of the present invention, complexity at a receiving end may be reduced by correcting a remaining distortion.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite broadcasting and communication transmitter, comprising:
a forward error correction (FEC) encoder to generate an FEC frame;
a bit mapping framer to perform bit mapping on the generated FEC frame; and
a predistorter to predistort the bit mapped frame.

2. The transmitter of claim 1, wherein the predistorter generates a predistortion symbol based on symbols of the bit mapped frame and performs predistortion using the generated predistortion symbol.

3. The transmitter of claim 2, wherein the predistorter calculates a sum of the symbols of the bit mapped frame based on design parameters associated with a memory component.

4. The transmitter of claim 1, the bit mapping framer performs bit mapping on the generated FEC frame based on a predetermined constellation.

5. The transmitter of claim 4, wherein the bit mapping framer performs the bit mapping on the generated FEC frame based on at least one of an applicable area and a status of a transmission channel.

6. The transmitter of claim 4, wherein the bit mapping framer performs the bit mapping based on at least one constellation among π/2 Binary Phase Shift Keying (BPSK), Quadrature Phase Shift Keying (QPSK), 8 Phase Shift Keying (8PSK), 16 Amplitude and Phase Shift Keying (16APSK), 32APSK, and 64APSK.

7. The transmitter of claim 4, wherein the bit mapping framer adds a physical layer (PL) header to the bit mapped frame.

8. The transmitter of claim 1, further comprising:
a baseband filtering modulator to perform baseband filtering modulation to wirelessly transmit the predistorted frame.

9. A satellite broadcasting and communication transmitting method, the method comprising:
generating, by a forward error correction (FEC) encoder, an FEC frame;
performing, by a bit mapping framer, bit mapping on the generated FEC frame; and
predistorting, by a predistorter, the bit mapped frame.

10. The method of claim 9, wherein the predistorting comprises:
generating a predistortion symbol based on symbols of the bit mapped frame; and
performing predistortion using the generated predistortion symbol.

11. The method of claim 10, wherein the generating of the predistortion symbol comprises:
calculating a sum of the symbols of the bit mapped frame based on design parameters associated with a memory component; and
generating the predistortion symbol based on a result of the calculating.

12. The method of claim 9, wherein the performing of the bit mapping comprises:
performing bit mapping on the generated FEC frame based on a predetermined constellation.

13. The method of claim 9, wherein the performing of the bit mapping comprises:
performing the bit mapping on the generated FEC frame based on at least one of an applicable area and a status of a transmission channel.

14. The method of claim 9, further comprising:
performing baseband filtering modulation by a baseband filtering modulator to wirelessly transmit the predisorted frame.
